(19) United States
(12) Patent Application Publication
(10) Pub. No.: US 2013/0203305 A1
(43) Pub. Date: Aug. 8, 2013

(54) HIGH-SPEED SEALIFT SYSTEM

(71) Applicant: Jong Soo Lee, Seoul (KR)

(72) Inventor: Jong Soo Lee, Seoul (KR)

(21) Appl. No.: 13/704,519

(22) PCT Filed: Jun. 20, 2011
(86) PCT No.: PCT/KR2011/004465

§ 371 Date: Jan. 23, 2013

(30) Foreign Application Priority Data
Jun. 28, 2010 (KR) 10-2010-0061297

(51) Int. Cl. B63H 19/00; B60F 3/00; B63B 35/00

(52) U.S. Cl. CPC B63H 19/00; B63B 35/00; B60F 3/0061
USPC 440/12.66; 440/113; 114/72

(57) ABSTRACT

The present invention relates to a high-speed sealift system which meets the requirement of the 21^{st} century. In the 21^{st} century, the indispensable requisites for a commercial sealift system that is to be deployed across the five oceans are high speed and stability. The present invention relates to a high-speed sealift system which operates at the super-high speed of 40 knots to 70 knots, and which is capable of the marine transport, in a quick and safe manner, of perishable goods, expensive capital goods, goods the volume or weight of which result in them being incapable of being transported via the air, strategic military goods, and capable of the large-scale redeployment of forces, and particularly, parts or equipment and materials which require a timely arrival. The sealift system of the present invention operates by means a marine transportation principle in which elevation force, found from Newton's law of physics that indicates that “the change of momentum of a body is proportional to the impulse impressed on the body,” is applied to tires. When a planning gear of the high-speed sealift system is lowered to enable tires to contact water at a speed higher than a predetermined threshold speed, the elevation force corresponding to the distribution weight of the system is generated at the contact surfaces of the tires, such that the system travels on the water at the travel speed of the tires. That is, the transportation effects of the system are the same as those achieved when a vehicle travels at a high speed on a highway with the tires thereof on the ground. According to one embodiment of the present invention, in which a 2000 ton high-speed sealift system is designed in accordance with the marine transportation principle of the present invention, the system is propelled by two 55,000 horsepower water jet pumps when traveling at a maximum high speed of 65 knots, while a total of 80 tires including 16 front tires and 64 rear tires support the weight of the system on the water at a speed of 5 knots or higher by planning components.

### TECHNICAL FIELD

In the 21^{st} century, the indispensable requisites for a commercial sealift system that is to be deployed across the five oceans are high speed and stability, and such a high speed sealift system is demanded which operates at the super-high speed of 40 knots to 70 knots, and which is capable of marine transport, in a quick and safe manner, of perishable goods, expensive capital goods, and cargoes whose volume or weight makes it difficult for air transport, and strategic military goods, and also which is capable of large-scale deployment of forces, and particularly, of parts or equipment and materials which require timely arrival (just-in-time).

While the existing sealift technology has formulated and utilized the static force of buoyancy, the dynamic force due to pressure difference, lift, as well as the man-made external force of air pressure to build and develop the sealift system, it has not met the demand for high speed of the 21^{st} century. To solve the above issues, while vessel shapes are modified, mono-hull fast ships with an appropriate Froude number and catamarans or trimarans for high speed stability have been developed to develop the super-high speed ship that can reach 70 knots. Nevertheless, such super-high speed ships can be driven based on their entire hull or part of the hull being underwater so that their thrust force per ton becomes elevated, which results in remarkable reduction of its environmental and economic characteristics. Therefore, a super-high speed and smooth sealift system that overcomes such difficulties can only be solved based on the new technology called “moving on the water surface”.

### BACKGROUND TECHNOLOGY

Searching for technology of the travelling on the water surface for the high speed sealift system of the present invention from natural phenomena, we find: the fact that the Basilisk lizard (so called Jesus lizard) runs on the water by treading water 20 times a second to catch its prey or to run away from predator threats (results of the research conducted by the Department of Biology at Harvard University, USA), and the fact that the concept of an elevation force is identified from the law of nature that “momentum change equals its impulse” related to Newtonian mechanics, and also we find the pebble skipping effect also known as “water sparrow” when a round and thin pebble thrown over the water results in its skipping on the surface of the water and eventually its sinking into the water; and we derive the concept of elevation force, and develop such concept into the principle of moving on water surface and apply this principle to tires: tires that can travel over the surface of water over a certain threshold speed were thus discovered, which has resulted in the birth of the high speed sealift system of the present invention.

### DETAILED DESCRIPTION OF THE INVENTION

### Technical Problem

According to the Advanced Mobility Concepts Study for the 21^{st} Century, requirements for the future mobility platform are summarized as the following five items.

A sealift system equipped with the following capabilities is required:

(1) It shall be capable of drastically reducing dependence on fixed infrastructures such as a harbor.

(2) It shall be capable of entering various points with natural advantages.

(3) It shall be capable of quickly mobilizing troops into a combat position.

(4) It shall be capable of performing vertical mobility operations.

(5) It shall be capable of offsetting the difference in the period of time between troop deployment and combat participation.

Nevertheless, in designing the high speed sealift system, the technology known so far has utilized buoyancy, lift, and air pressure. In addition, in order to minimize the drag from navigation, the mono hull, the catamaran intended to maintain stability against wave height and trimarans are combined with air pressure, buoyancy, and hydrofoil effects to operate and develop the high speed transport system. However, the above five requirements have not been satisfied. Furthermore, while the ship with the wing-in-ground effect has been claimed to be able to carry a larger quantity of cargo at a speed exceeding 300 knots, it is thought to require verification over a long period concerning whether such an effect may also be available even under severe weather with rough waves.

### Means for Solving Technical Problem

The five requirements above that have been presented as demands by the Advanced Mobility Concepts Study of the 21^{st} Century, cannot be satisfied by the prior art based on buoyancy, lift and air pressure or wing-in ground effect only, so a new sealift technology must be developed.

Therefore, the present invention started from the law of nature that “momentum change equals its impulse” of Newtonian physics as a new sealift principle, and it has been discovered that a certain rotating object that collides with water can travel on the water surface at higher speed above its threshold speed by a force that can mate with and rotate on the water surface, that is, the elevation force. The principle of moving on the water surface by the elevation force of the present invention may be described as follows:

When a tire “0” having the distribution weight of “ΔMg” in a certain transport system rotates at a certain angular velocity of “ω” on a certain face “10” (herein, the water surface), the its centrifugal force “F_{R}” exerted on the applicable face “10” by the applicable distribution mass “ΔM” during the instant of contacting the applicable face “10”, “Δt”, is expressed as follows:

F_{R}=ΔMRω² (1)

It is assumed that such centrifugal force “F_{R}” act as the repulsive force by an equilibrium in response to the distribution weight “ΔMg” of the applicable system (Principle of Superposition), that is,

F_{W}=ΔMg=ΔMU²/R=F_{R} (2)

Herein, the relation equation for the driving speed of the tire “0”, “U=Rω”, was used. The threshold speed “U_{CR}” by which the centrifugal force of the tire reaches its force equilibrium with the distribution weight of the applicable system is expressed as follows:

U_{CR}=\sqrt{Rg} (3)

At such threshold speed “U_{CR}”, the condition under which the applicable tire needs to stay on the water surface to become parallel with the water surface during the threshold instance “Δt” is described below:

μΔMg×Δt=ΔMU_{CR}−0 (4)

Herein, “μ” was assumed to be the coefficient of coulomb rolling friction between the tire and the water surface. In addition, when the tire “0” collides vertically with the water surface, the condition under which the tire needs to stay on the water surface during the threshold instant “Δt” is given as follows, provided that the vertical speed component of the tire with respect to the water surface “10” is set as “V”:

ΔMg×Δt=ΔMV−0 (5)

Then the threshold instant “Δt” may be expressed as follows utilizing Equations (4) and (5):

$$Δ t = \frac{V}{g} = \frac{{U}_{CR}}{μ g} \qquad ( 6 )$$

Herein, assuming that the tire, upon contacting the water surface, collide with the water surface at the centrifugal acceleration of “a_{R}=U²_{CR}/R” during the threshold instant of “Δt”, the vertical speed component of the tire “0”, “V”, is given as follows:

$$V = \frac{{U}_{CR}^{2}}{R} \times Δ t \qquad ( 7 )$$

On the other hand, the following relation equation is obtained from Equation (6):

$$μ = \frac{{U}_{CR}}{V} \qquad ( 8 )$$

Assuming that the applicable tire “0” mate and rotate under the rated friction condition (no slip condition) at the threshold speed of “U_{CR}”, “μ=1.0” is established and then substituted into Equation (7) so that the value at the threshold instant is expressed as follows:

$$Δ t = \sqrt{\frac{R}{g}} \qquad ( 9 )$$

That is, when the applicable tire “0” travels at the threshold speed of “U_{CR}=√Rg”, it stays on the water surface due to the repulsive force from the water surface during the threshold instant of “Δt=√R/g”, and if such condition is continuously satisfied, the applicable tire “0” naturally travels on the water surface “10”.

Now, since the present invention resulted in the discovery of the condition that enables the tire “0” to move on the water surface, the size and number of the tires “0” that are suitable for the high speed sealift system of the present invention may be determined based on the above. In addition, taking the transport stability of a system into account, its center of gravity is located in front of its center of pressure so that the numbers of front and rear tires may be determined according to weight distribution. The required power may be found from the following equation according to the maximum speed of the system, “Uₘₐₓ”:

$$HP = Mg \times {U}_{Max} + \frac{1}{2} ρ \times {A}_{D} \times {U}_{Max}^{3} / ( η \times 750 ) \qquad ( 10 )$$

In Equation (10), “ρ” is the density of water, “A_{D}” the drag cross-section area of the system, and “η” a power efficiency, respectively. For example, if the total carrying weight of the high speed sealift system of the present invention is 2,000 tons and its maximum speed is 65 knots, 2 water jet pumps of 55,000 hp each are required.

### Advantageous Effects

When a high speed sealift system is designed and built according to the principle of moving on the water surface of the present invention and commissioned as the high speed sealift system, upon lowering its planning gears over its threshold speed and contacting the water surface with its applicable tires, the tire surfaces mate with the water surface and undergo rotation to enable them to travel on the water surface at such a high speed that the system becomes capable of marine transport in a quick and safe manner, of perishable goods, expensive capital goods, and cargoes whose volume or weight makes it difficult for air transport, and strategic military goods, and is capable of large-scale deployment of forces, particularly, of parts or equipment and materials which require timely arrival. In particular, it enables waterborne maneuvers and operations with troops and equipment in the combat stance required by the advanced mobility platform for the future and can advance into any seashore so that the seamless transition between troop deployment and combat participation may be maximally achieved, which effectively enables landing operations to be performed resolutely as required by the 21^{st} century.

In addition, the high speed sealift system of the present invention represents an economic sealift system, wherein it has such high transport efficiency by travelling on the water surface with tires that it consumes as much power as that required for a vehicle to travel on a highway.

### BRIEF DESCRIPTION OF THE DRAWINGS

FIG. 1 is an oblique diagram showing the maneuvering ship in operation that travels fast over the water surface with planning of its tires while communicating with a helicopter.

FIG. 2 is a conceptual diagram showing the repulsive force that is required for tires to stay on the water surface according to the principle of moving on the water surface of the present invention.

FIG. 3 is a conceptual diagram showing that the law of nature related to the principle of moving on the water principle of the present invention and the Newtonian mechanics describing that “momentum change equals its impulse” may be applicable to the parallel and vertical relations between a tire and the water surface.

FIG. 4 is a descriptive diagram showing that, when the tire of the high speed sealift system of the present system travels on the water, the internal pressure of one tire becomes equivalent to the distribution weight of the high speed sealift system.

FIG. 5 is a detailed diagram showing an embodiment of the high speed sealift system of the present invention.

FIG. 6 is a conceptual diagram showing the operation of the planning gear of the high speed sealift system of the present invention.

FIG. 7 is an oblique diagram showing an embodiment in which an example of the present invention, a high speed cargo ship is berthing at the seashore and deploying combat vehicles upon undertaking a 21^{st} century landing operation.

### BEST MODE OF OPERATION OF THE INVENTION

The present invention starts from the law of nature related to Newtonian physics that “momentum change equals its impulse” and leads to the discovery of the “principle of moving on the water surface” in which applicable tires mate with and rotate on the water surface at a threshold speed based on rolling friction during the threshold instant, and relates to application of the principle to the high speed sealift system. Specific application cases intended to implement the present invention are presented as examples.

### Embodiments of the Invention

As an example of the present invention, it starts from the law of nature related to such Newtonian mechanics that “momentum change equals its impulse” and leads to the discovery of the elevation force and then results in its advancement as the principle of moving on the water surface, wherein a series of theoretical implementation processes for application to tires are described, and the progress leading to the birth of a high speed cargo ship that satisfies the mobility platform for the future is described.

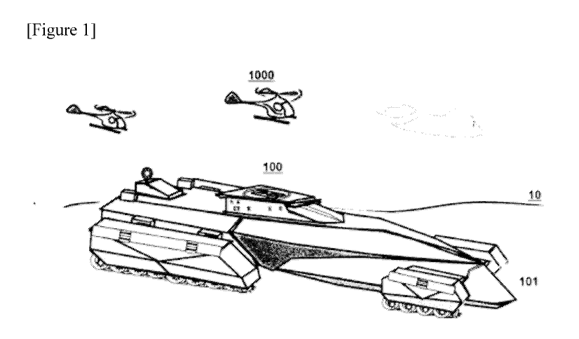

FIG. 1 is an example of the high speed sealift system of the present invention wherein a high speed cargo ship 100 that satisfies the demands of the mobility platform of the 21^{st} century is cruising over the water surface 10 at higher speed while communicating with a helicopter 1000 and showing its front part 101 that can open for unloading cargoes during a landing operation.

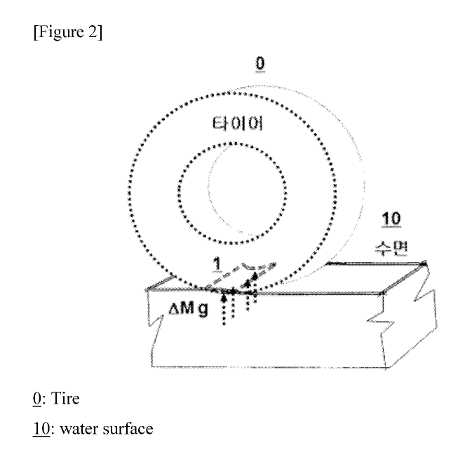

FIG. 2 depicts the principle moving on the water surface of the present invention, wherein, in order for the tire 0 to stay on the water surface 10, a water surface pressure corresponding to the distribution weight of an applicable system, “ΔMg”, must be generated on the contact surface 1 between the tire 0 and the water surface 10.

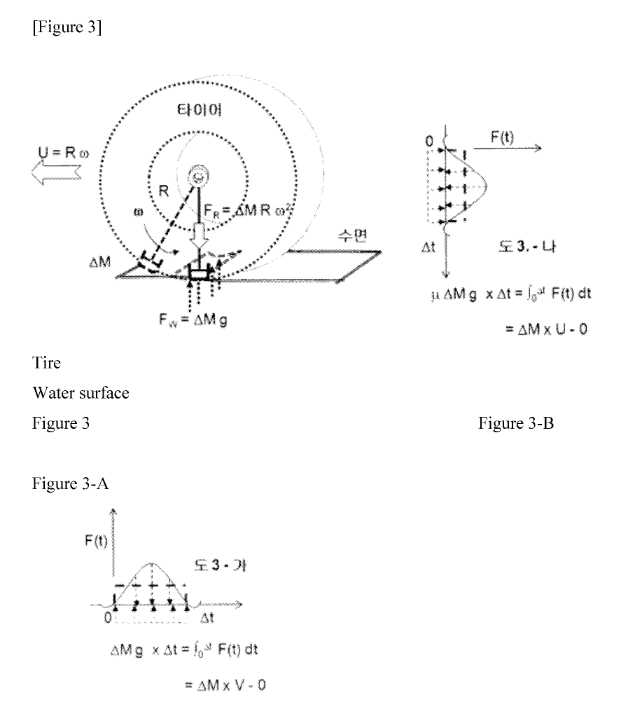

FIG. 3 describes a series of processes involved in the present invention, wherein, as for the condition under which the applicable tire 0 with a radius “R” needs to stay on the water surface 10, upon moving on water surface 10 at the speed “U=Rω” and a certain angular velocity “ω”, the centrifugal force “F_{R}=ΔMU²/R” acts on the water surface 10 upon contacting the water surface 10, and then the repulsive force “F_{W}=ΔMg” is generated from the contact surface 1 with the water surface 10, and the resulting speed is called the threshold speed “U_{CR}=√Rg” and the stay lasts instantly during the applicable threshold instant “Δt=√R/g”.

To support the above description, starting from the law of nature related to Newtonian mechanics that “momentum change equal its impulse,” and considering that the impulse to the mean force “ΔMg” with respect to the repulsive force “F(t)” that an applicable tire 0 exerts vertically on the water surface 10 during a certain threshold stay instant “Δt” is equal to the change in momentum “ΔM×V−0”, the elevation force which results from vertical collision between the tire 0 and the water surface 10, “ΔMg” and the elevation force which results from a horizontal partial force due to rolling friction, “μΔMg”, are generated so that the applicable tire 0 travels over the water surface 10 provided that the impulse to the mean horizontal repulsive force “μΔMg” becomes equal to the momentum change in a horizontal direction “ΔM×U−0”.

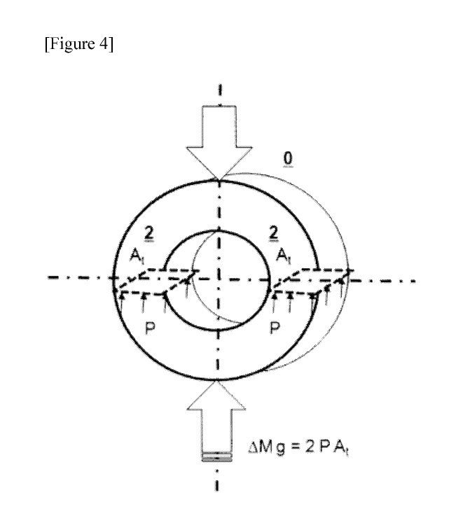

FIG. 4 is a conceptual diagram intended to determine the specifications for the tire 0 that travels on water in the high speed sealift system of the present invention. After the internal pressure of the tire is adopted as the 200 psi class considering aviation applications and the threshold stay instant is set as “0.27 sec”, the radius of the tire may be expressed by the following equation:

R=g×Δt² (11)

Then, the radius of the tire 0 becomes 0.715 m, and if a total of 80 tires are applied, the system distribution weight exerted on each tire is 25 tons and the internal surface area of the tire, Aₜ, is 806.45 cm², so that the width of the tire 0 becomes 304.8 mm, and 16 tires on both side of the front and 64 tires on both sides of the rear are respectively mounted on the planning gear.

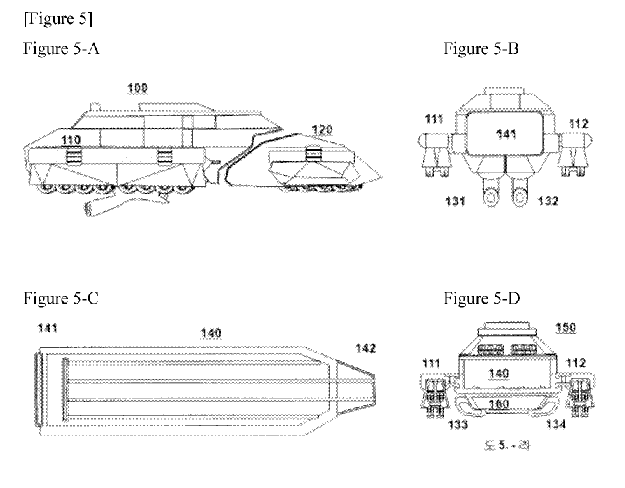

FIG. 5-A is a lateral oblique diagram showing the high speed mobility cargo ship 100 as an example of the high speed sealift system of the present invention in which its front and rear planning gear housings 110 and 120 are shown. In FIG. 5-B are illustrated its main propulsion engines including left and right propulsion nozzles 131 and 132 of its water jet pump 130. In FIG. 5-C is shown the cargo loading chamber 140 which is furnished with a guide bridge 142 in the front and a large open/close door 141 in the rear and used for landing tasks 200, etc. FIG. 5-D is a cross-sectional diagram of the high speed cargo ship 100, wherein, starting from the bottom, left and right suction ports of a water jet 133 and 134 and an engine room 160 are located in the lowest compartment, the cargo loading chamber 140 is configured above them, left and right sections of the external side are interfaced with planning gear housings 111 and 112, and the uppermost compartment is comprised of cabins 150. In one example of the present invention, a high speed cargo ship 100 of the 2000-ton class may be loaded with 30 units of amphibious combat vehicles of the 20-ton class, and its cabins 150 can accommodate 400 fully armed troops. In addition, 2 water jet pumps of 55,000 tons each may be mounted in its engine room 160.

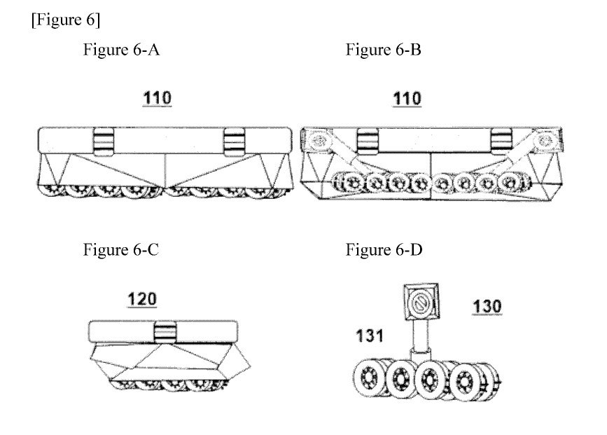

FIG. 6 shows the operation condition of the planning gear equipped with the tire 0. FIG. 6-A shows the condition of the high speed sealift system 100 of the present invention in which its planning gear has been lowered from its rear planning gear housing 110 to the water surface 10 for travelling on the water surface. FIG. 6-B shows the condition in which its planning gear has been lifted into its rear planning gear housing 110 at the threshold speed or less. FIG. 6-C shows the condition in which its planning gear has been lowered from its front planning gear housing 120 to the water surface 10, while FIG. 6-D represents a specific structure of the planning gear device 130 and shows its planning hydraulic cylinder 131.

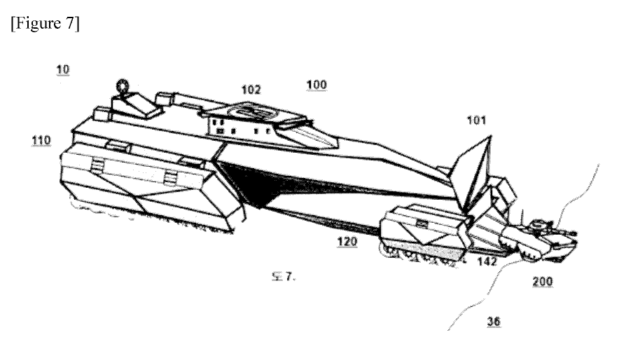

FIG. 7 shows the conditions of the example of the present invention, a high speed cargo ship 100, wherein it enters the shore behind enemy lines and opens up its front unloading area 101, and tanks 200 are landed resolutely on the guide bridge 142; the extent of immersion of the tires at its rear planning gear housing 110 and front planning gear housing 120 are visible according to the water depth from the water surface 10, and a heliport 102 is visible on top of its hull. As is shown in this figure, the high speed cargo ship 100 which is the example of the present invention represents the first system travelling on water surface, which can satisfy the 5 requirements of the future mobility platform according to the Advanced Mobility Concepts Study for the 21^{st} Century.

### INDUSTRIAL AVAILABILITY

The present invention relates to a discovery of the elevation force based on the law of Newtonian physics that “momentum change equals its impulse” and to the high speed sealift system that is propelled according to the principle of moving on water surface by applying it to its tires, wherein 2-wheel motorcycles, 4-wheel passenger systems, and ground transportation vehicles carrying large cargoes that operate by using tires may be converted into sealift systems to apply the present invention in the same way that vehicles are driven on the highway, and also represents a high speed sealift system based on the advanced technology of moving on the water surface as being demanded in the 21^{st} century whose scope may be expanded to high speed ferries, container vessels, and ultra-large oil tankers.

### BIBLIOGRAPHY

### Patent Literature

1. Tony Croft Giles Company Incorporated, USA “FAST SEALIFT SHIP AND TRANSPORTING METHOD” Registration Number (Date) 1002550750000 (20000210).
2. “MONO HULL FAST SHIP” Registration Number (Date) 1001432460000, (19980407).

### Non-Patent Literature

1. Douglas Holtz-Eakin Director of US Congressional Budget Office “Options for Strategic Military Transportation Systems” September 2005.
2. Jon D. Klaus US National Defense Fellow “Strategic Mobility Innovation: Options and Oversight Issues” CRS Report for Congress, Apr. 29, 2005.
3, William A. Johnsen “Advances in the Design of Pavement Surfaces” A Dissertation WORCESTER POLYTECHNIC INSTITUTE Dec. 19, 1997

1. A high speed sealift system, wherein, starting from the law of nature related to Newtonian physics that “momentum change equals its impulse,” a principle of moving on the water surface, whereby a certain rotating object, upon colliding with the water surface, can stay above its threshold speed for a threshold instant due to the power by which it can mate with and rotate on the water surface and can travel on the water surface at higher speed, is applied to tires, and the applicable tires are mounted on planning gear so that planning of the applicable tires results in high speed travelling on the water surface over the threshold speed.

2. The high speed sealift system according to claim 1, wherein the threshold speed “U_{CR}” and the threshold instant “Δt” of the applicable tire are functions of the radius of a tire, and if it travels at “U_{CR}=√Rg”, it stays for the threshold instant of “Δt=√R/g” due to the repulsive force from the water surface, that is, the elevation force “ΔMg”, and if such conditions are continuously satisfied, the applicable tire “0” travels on the water surface “10” naturally.

3. The high speed sealift system according to claim 1, wherein the planning gear of the applicable system is lifted at the threshold speed or less and lowered over the threshold speed so that the applicable tire, upon contacting the water surface, travels on the water surface at higher speed according to the theory of moving on the water surface in that it mates with and rotates on the water surface based on rolling friction.

4. The high speed sealift system according to claim 1, wherein the power required to travel on the water surface at higher speed by planning of the applicable tire is found by the following equation according to the maximum speed requirement of the system “Uₘₐₓ”, and it travels on the water surface with the economical transportation efficiency as the vehicles running on the highway.
$$HP = Mg \times {U}_{Max} + \frac{1}{2} ρ \times {A}_{D} \times {U}_{Max}^{3} / ( η \times 750 ) \qquad ( 10 )$$
[In Equation (10), “ρ” is the density of water, “A_{D}” the drag cross-section area of the system, and “η” the power efficiency, respectively.]

5. The high speed sealift system according to claim 1, wherein if the number of tires and their internal pressures are set up according to weight distribution of the applicable system and its threshold stay instant “Δt” is specified, the radius of the tire may be expressed by the following equation,
R=g×Δt² (11)
and it travels on the water surface at higher speed by planning of the water travelling tire with the predetermined specification.

6. A high speed sealift system equipped with the capability for resolutely performing landing operations required in the 21^{st} century, wherein the high speed cargo ship 100 to which the principle of moving on the water surface of the present invention has been applied can transport troops and equipment within an operation time limit, can perform waterborne maneuvering operations with troops and equipment quickly based on the combat stance required by the future mobility platform, can approach any seashore and open its front part 101 so as to resolutely carry out the landing of tanks 200 via its guide bridge 142, and can drastically reduce the time difference between the deployment of troops and their participation in combat.

7. A high speed sealift system based on the advanced technology for travelling on water, wherein 2-wheel motorcycles, 4-wheel passenger systems, and ground transportation vehicles carrying large cargoes that operate by using tires may be converted into sealift systems to apply the present invention, and its scope may be expanded to high speed ferries, container vessels, and ultra-large oil tankers.
